(19) United States
(12) Patent Application Publication
(10) Pub. No.: US 2004/0114140 A1
(43) Pub. Date: Jun. 17, 2004

(54) Light scattering particle characterisation apparatus and detection means suitable therefor

(76) Inventor: Roger John White, Arbroath (GB)

Correspondence Address: Test Hurwitz & Thibeault, Patent Administrator, 125 High Street, Boston, MA, 02110, US

(21) Appl. No.: 10/466,953

(22) PCT Filed: Jan. 22, 2002
(86) PCT No.: PCT/GB02/00266

(30) Foreign Application Priority Data
Jan. 22, 2001 (GB) 0101475.2

(51) Int. Cl. G01N 21/00; G01N 21/49

(52) U.S. Cl. 356/338

(57) ABSTRACT

A particle characterisation apparatus (10) (FIG. 1) comprises a test cell (12) arranged to contain a sample, or test medium, (14) and an optical radiation source (16) aligned so that it emits radiation directed to be incident on the test medium (14). The optical radiation incident on the test medium (14) is scattered and the scattered components are collected by optical waveguides (18) having collecting terminations (20) radially disposed about the test cell (12) at predetermined angular positions. The collected optical radiation is carried by the waveguides from the test cell and emitted through radiation emitting terminations (24) into detection means (22). The detection means (22) comprises detectors (28) mounted on a rotatable carrier (30) and disposed in alignment with the radiation emitting terminations to detect the optical radiation being emitted therefrom. In use, each detector (28) is rotated to sequentially detect the radiation emitted from each emitting termination (24) in turn.

The present invention relates to the detection of optical radiation from an array of waveguides and more particularly to waveguides associated with particle characterisation apparatus, particularly light scattering apparatus, as well as to such particle characterisation apparatus itself.

In this specification the term “optical radiation” means electromagnetic radiation in the visible, near infra-red and near ultra-violet part of the electromagnetic spectrum.

As polymers and biopolymers become of increasing interest in a number of industrial sectors a need has arisen to continuously improve analytical apparatus to determine the molecular properties of these materials.

Multi-angle light scattering, in which optical radiation incident upon, and scattered by, a sample of a material is detected by a photometer, or photodetector, has been an established technique for molecular characterisation for more than fifty years. During this time the photometers used have been of two basic types. One type is the Goniometer which comprises a simple light source fixed in relation to a cylindrical flow cell which contains the sample material to be analysed. Light from the source is incident on the sample material and scattering of the light induced, and the resulting intensity of the scattered light is measured at various angles in relation to the incident light using a simple photo multiplier which moves around the flow cell. The apparatus has the advantage of being able to measure at any angle between 0° and 360°. However, it has the disadvantages of taking a long time to complete the measurement and its size limits it use in certain areas of material analysis.

A system which is currently used in industrial applications is the multi angle light scattering system (MALS) developed by Wyatt Technology Corporation of California. This system comprises a solid state red laser light source from which radiation is incident on a sample disposed within a flow cell. The scattered light intensity is simultaneously measured at two or more fixed angles by an array of eighteen detectors fixed at around the flow cell.

This system allows rapid determination of material characteristics; such as molar mass, at speeds which allow it to be used with flow through separation systems.

The disadvantages of this system are that the detector array is fixed at particular angles in relation to the incident light source and that the requirement of eighteen detectors makes it, potentially, an expensive system. The sensitivity of the system is also limited by use of red laser in combination with corresponding detectors. Use of other light sources and detectors would make it prohibitively expensive. The relatively large size of the system also inhibits the ability of the system to integrate with other, more compact systems.

It is known to have optical detection means remote from a source, such as the cell of such characterisation apparatus, whereby the scattered radiation is transmitted by optical waveguides associated with the different scatter angles to be detected.

Notwithstanding such apparatus as an immediate source of such optical radiation for detection means, it will be understood that such optical waveguides may convey radiation from other apparatus, and preserving the generality of the foregoing, it is an object of this invention is to provide detection means for detecting radiation from such waveguide array, including optical radiation emitted from particle characterisation apparatus, which mitigates the aforesaid disadvantages. It is also an object of this invention to provide particle characterisation apparatus comprising such detection means.

According to a first aspect of the present invention detection means, for detecting characteristics of optical radiation carried by a plurality of waveguides terminating at the detection means, has at least one radiation detector operable to be optically aligned with a radiation emitting termination of at least one waveguide to receive said optical radiation therefrom, characterised by fewer detectors than waveguide terminations and optical alignment means operable to align the or each radiation detector with respect to a plurality of said waveguide terminations sequentially.

According to a second aspect of the present invention a particle characterisation apparatus comprises

a test cell arranged to contain a test medium,

means to direct the optical radiation into the cell along a datum direction,

a source of optical radiation,

radiation collection means disposed at the boundary of the cell to collect optical

radiation scattered by a contained test medium,

said radiation collection means comprising a plurality of optical waveguides, each having a radiation collecting termination, disposed with said radiation collecting terminations arrayed about the cell boundaries in predetermined spatial relationship with respect to the datum direction, and

detection means as claimed in any one of the preceding claims.

Embodiments of the present invention will be described further, by way of example, with reference to the accompanying drawings in which:

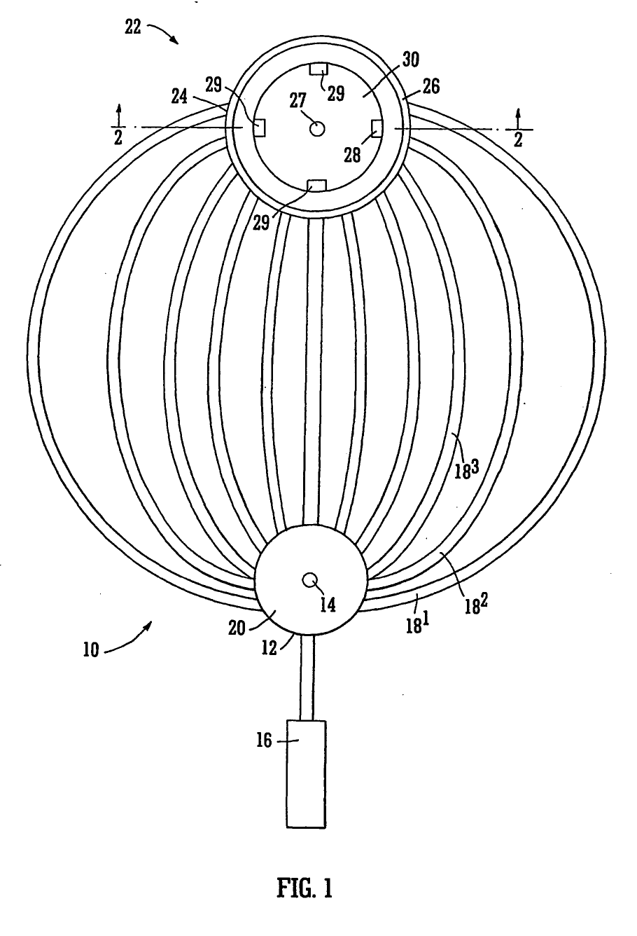

FIG. 1 is a schematic diagram showing detection means as part of particle characterisation apparatus according to the present invention;

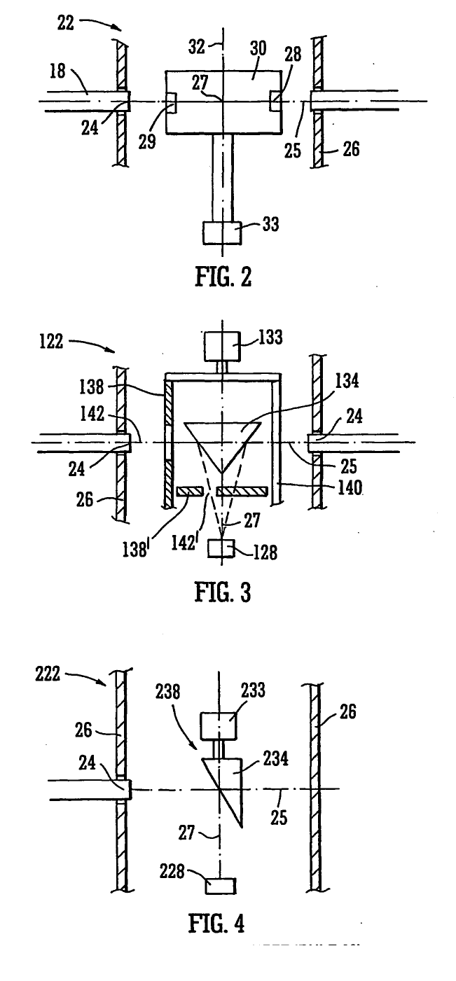

FIG. 2 is a schematic diagram showing the detection means of FIG. 1 in sectional elevation along the line 2-2 thereof;

FIG. 3 is a schematic diagram, and showing in sectional elevation a second embodiment of the detection means of FIG. 2, and

FIG. 4 is a schematic diagram showing in sectional elevation a third embodiment of the detection means of FIG. 2.

Referring to FIG. 1 a particle characterisation apparatus 10 comprises a test cell 12 arranged to contain a sample, or test medium 14 and an optical radiation source 16, which may advantageously be a laser, aligned so that it emits radiation directed to be incident on the test medium 14. The laser may be such that it operates in the blue region or the red region of the visible electromagnetic spectrum or just outside of the visible spectrum depending on the characterisation requirements.

The optical radiation incident on the test medium 14 is scattered and the scattered components are collected by radiation collection means 18, which comprise optical waveguides 18₁, 18₂, 18₃ . . . , through radiation collecting terminations 20 radially disposed about the test cell 12 at predetermined angular positions. The collected optical radiation is carried by the waveguides from the test cell and emitted through radiation emitting terminations 24 into detection means 22. Referring also to FIG. 2, the detection means comprises a housing 26 in the wall of which the radiation emitting terminations 24 are radially disposed. The waveguide terminations 24 are aligned with respect to the housing to lie substantially in a single plane 25 adjacent each other and emit radiation therefrom in that plane towards a single point 27. One or more detectors 28, four as shown, are mounted on a carrier 30 which is rotatable about a rotational axis 32 which extends as a transverse axis perpendicular to the single plane 25 and passes through the single point 27. When multiple detectors 28 are mounted they may be optimised to detect optical radiation of the same wavelength or alternatively each or some of the detection may be optimised to detect radiation of differing wavelengths. The detectors 28 are mounted to face radially outwards from the rotational axis 32 towards a radiation emitting termination 24.

In use the carrier 30 is rotated about the rotational axis 32 by motor 33 which acts as an addressing means such that the or each detector 28 is directed towards, that is, addresses, an individual radiation emitting termination 24 sequentially, to detect the radiation emitted from each in turn and thereby also provide multiplexing means.

In FIG. 3 a second embodiment of the detection means 122 comprises the housing 26 in the wall of which the radiation emitting terminations 24 are radially disposed. Within the housing 122 optical alignment means 134, are disposed so as to redirect radiation emitted from the radiation emitting terminations 24 from the single plane 25 and substantially along transverse axis 27 into the field of view of a fixed detector 136. The optical alignment means 134 provides a field of view for the detector 136 to each of the waveguide terminations simultaneously. Addressing means 138 comprises masking means 140 which inhibits radiation from terminations 24 and a window 142 for permitting the detector 136 to be exposed to the emitted radiation from an individual waveguide termination. The masking means 140 may be optoelectronic and switchable between transparency and opacity to define the window 142 and the switched transparent part thereof moved electronically about transverse axis 27 to address the waveguide terminations sequentially. Alternatively, the window 142 may be one or more optically transmissive apertures within the masking means 140 addressing the terminations by physical rotation by way of motor 133 about transverse axis 27.

Referring to FIG. 4 a third embodiment of the detection means 222 comprises the housing 26 in the wall of which the radiation emitting terminations 24 are radially disposed in single plane 25. Within the housing 26 optical alignment means 234, rotatable about transverse axis 27 perpendicular to the single plane 25, comprises a plane mirror or prism disposed to redirect radiation emitted from a single waveguide termination 24 into the field of view of a fixed detector 236. The detection means 22 also comprises addressing means 238 which may be a motor which is operable to rotate the alignment means about the transverse axis 27 and thereby causes the detector to address each waveguide termination in turn.

Although the second and third embodiments each show a single radiation detector, a plurality of detectors may be used at each location, and some of them may be responsive to radiation in different wavebands than others.

The detectors 28, 136,236 are preferably responsive to radiation at a boundary of or beyond the visible spectrum and are advantageously responsive beyond the short wavelength end of the visible spectrum.

Preferably the source 16 is arranged to emit radiation in the blue or near ultra violet part of the spectrum, that is, with a small wavelength, permitting maximum packing of waveguides and maximum resolution of measurement.

Advantageously the component parts of the particle characterisation apparatus including the detection means, can be integrated onto a single substrate to interface with other apparatus.

1. Detection means for detecting characteristics of optical radiation carried by a plurality of waveguides terminating at the detection means, the detection means having at least one radiation detector operable to be optically aligned with a radiation emitting termination of at least one waveguide to receive said optical radiation therefrom, characterised by fewer detectors than waveguide terminations and optical alignment means operable to align the or each radiation detector with respect to a plurality of said waveguide terminations sequentially.

2. Detection means as claimed in claim 1 including housing means arranged to align the waveguide terminations to lie substantially in a single plane adjacent each other and emit optical radiation therefrom in said single plane.

3. Detection means as claimed in claim 2 in which the waveguide terminations are arrayed about and directed towards a single point in said single plane and lying on a transverse axis, extending perpendicular to said single plane.

4. Detection means as claimed in any one of claims 1 to 3 in which the optical alignment means is operable to provide each radiation detector with a field of view limited to a single waveguide termination and includes addressing means operable to move the field of view between waveguide terminations sequentially.

5. Detection means as claimed in claim 4 when dependant upon claim 3 in which the or each radiation detector is mounted on a carrier rotatable about the transverse axis and facing radially outwardly from the axis in said single plane towards a waveguide termination, and the addressing means comprises motor means operable to rotate the carrier about the axis such that the detector is directed towards an individual waveguide termination sequentially.

6. Detection mens as claimed in any one of claims 1 to 3 in which the optical alignment means is operable to provide each radiation detector with a field of view encompassing a plurality of waveguide terminations and includes addressing means operable to interrupt the field of view between said plurality of waveguide terminations and the detector and restore said field of view to individual waveguide terminations sequentially.

7. Detection means as claimed in claim 4 or claim 6 in which the optical alignment means include radiation deflection means associated with the or each radiation detector operable to deflect optical radiation from each waveguide termination within its field of view towards the radiation detector.

8. Detection means as claimed in claim 7 when dependant on claim 3 in which the radiation detector is disposed out of the single plane.

9. Detection means as claimed in claim 8 in which the radiation detector is disposed to receive radiation along the transverse axis perpendicular to the plane.

10. Detection means as claimed in any one of claims 7 to 9 in which the radiation deflection means includes one or more optical elements rotatable about said transverse axis.

11. Detection means as claimed in any one of claims 6 to 9 in which the addressing means comprises masking means operable to inhibit radiation from said waveguide terminations reaching the detector and the addressing means comprising window means for the radiation operable to be disposed between the or each radiation detector and each said associated termination sequentially.

12. Detection means as claimed in claim 11 in which the masking means is optoelectronic and switchable between transparency and opacity to said radiation to define said window means.

13. Detection means as claimed in claim 11 in which the masking means extends about the transverse axis and the window means comprises one or more optically transmissive positions about said axis of the masking means rotatable about the axis.

14. Detection means as claimed in any one of the preceding claims including a plurality of radiation detectors, at least some of the detectors being responsive to radiation in different wavebands than others.

15. Detection means as claimed in any one of claims 1 to 13 in which the or each optical radiation detector is responsive to radiation at a boundary of or beyond, the visible spectrum.

16. Detection means as claimed in claim 15 in which the radiation detector is responsive to radiation at or beyond the short wavelength end of the visible spectrum.

17. Detection means for detecting characteristics of optical radiation carried by a plurality of waveguides terminating at the detection means, substantially as herein described with reference to, and as shown in, the accompanying drawing.

18. A particle characterisation apparatus comprising
a test cell arranged to contain a test medium,
means to direct the optical radiation into the cell along a datum direction,
a source of optical radiation,
radiation collection means disposed at the boundary of the cell to collect optical
radiation scattered by a contained test medium,
said radiation collection means comprising a plurality of optical waveguides, each having a radiation collecting termination, disposed with said radiation collecting terminations arrayed about the cell boundaries in predetermined spatial relationship with respect to the datum direction, and
detection means as claimed in any one of the preceding claims.

19. A particle characterisation apparatus as claimed in claim 19 in which the source of optical radiation is arranged to emit radiation in the blue or near ultra violet part of the spectrum.

20. A particle characterisation apparatus as claimed in claim 19 or claim 20 in which the source of optical radiation, the test cell, radiation collection means and detection means are integrated onto a single substrate.

21. A particle characterisation apparatus substantially as herein described with reference to, as shown in, the accompanying drawing.
